(19) United States
(12) Patent Application Publication
(10) Pub. No.: US 2023/0373472 A1
(43) Pub. Date: Nov. 23, 2023

(54) DRIVING ASSISTANCE DEVICE, DRIVING ASSISTANCE METHOD,AND PROGRAM

(71) Applicant: TOYOTA JIDOSHA KABUSHIKI KAISHA, Toyota-shi Aichi-ken (JP)

(72) Inventor: Kosuke WATANABE, Miyoshi-shi Aichi-ken (JP)

(73) Assignee: TOYOTA JIDOSHA KABUSHJIKI KAISHA, Toyota-shi Aichi-ken (JP)

(21) Appl. No.: 18/197,946

(22) Filed: May 16, 2023

(30) Foreign Application Priority Data
May 17, 2022 (JP) 2022-080630

(51) Int. Cl. B60W 30/09

(52) U.S. Cl. CPC B60W 30/09; B60T 7/22

(57) ABSTRACT

To effectively prevent a driver from being annoyed, provided is a driving assistance device (1) including: a target acquisition unit (30) configured to acquire a target existing in a periphery of an own vehicle; and a control unit (10) configured to execute, when the target acquired by the target acquisition unit (30) is determined as an object to be avoided which is highly likely to collide with the own vehicle, collision avoidance control of controlling travel of the own vehicle such that the collision between the own vehicle and the object to be avoided is avoided. The control unit (10) is configured to suppress the collision avoidance control when a specific target (ST) is detected between the own vehicle and the object to be avoided, and a positional relationship among the specific target (ST), the object to be avoided, and the own vehicle satisfies a predetermined condition.

### CROSS-REFERENCE TO RELATED APPLICATION

This application claims priority to Japanese Patent Application No. JP 2022-080630 filed on May 17, 2022, the content of which is hereby incorporated by reference in its entirety into this application.

### BACKGROUND

### 1. Technical Field

The present disclosure relates to a driving assistance device, a driving assistance method, and a program.

### 2. Description of the Related Art

In Japanese Patent Application Laid-open No. 2011-105250, there is disclosed a device which calculates, when an object to be avoided such as a pedestrian or another vehicle is detected in a traveling direction of an own vehicle, a predicted time to collision between the detected object to be avoided and the own vehicle, and operates an automatic braking system when the predicted time to collision is equal to or shorter than a predetermined threshold value.

There is a case in which a wheel stop (car stop) or the like which stops a vehicle at a desired position is installed in a parking space and the like. The device as described in Japanese Patent Application Laid-open No. 2011-105250 operates the automatic braking system when the predicted time to collision is equal to or shorter than the predetermined threshold value even in a case in which the collision between the own vehicle and the object to be avoided can be avoided by a wheel stop or the like. That is, there is a problem in that the automatic braking system unnecessarily operates, and hence a driver is annoyed.

### SUMMARY

The present disclosure has been made in order to solve the above-mentioned problem. That is, one object of the present disclosure is to effectively prevent a driver from being annoyed.

According to at least one embodiment of the present disclosure, there is provided a driving assistance device (1) including: a target acquisition unit (30) configured to acquire a target existing in a periphery of an own vehicle (SV); and a control unit (10) configured to execute, when the target acquired by the target acquisition unit (30) is determined as an object to be avoided (OB) which is highly likely to collide with the own vehicle (SV), collision avoidance control of controlling travel of the own vehicle (SV) such that the collision between the own vehicle (SV) and the object to be avoided (OB) is avoided, wherein the control unit (10) is configured to suppress the collision avoidance control when a specific target (ST) is detected between the own vehicle (SV) and the object to be avoided (OB), and a positional relationship among the specific target (ST), the object to be avoided (OB), and the own vehicle (SV) satisfies a predetermined condition.

According to at least one embodiment of the present disclosure, there is provided a driving assistance method including: acquiring a target existing in a periphery of an own vehicle (SV); executing, when the acquired target is determined as an object to be avoided (OB) which is highly likely to collide with the own vehicle (SV), collision avoidance control of controlling travel of the own vehicle (SV) such that the collision between the own vehicle (SV) and the object to be avoided (OB) is avoided; and suppressing the collision avoidance control when a specific target (ST) is detected between the own vehicle (SV) and the object to be avoided (OB), and a positional relationship among the specific target (ST), the object to be avoided (OB), and the own vehicle (SV) satisfies a predetermined relationship.

According to at least one embodiment of the present disclosure, there is provided a program for causing a computer of a driving assistance device (1) for acquiring a target existing in a periphery of an own vehicle (SV), and executing, when the acquired target is determined as an object to be avoided (OB) which is highly likely to collide with the own vehicle (SV), collision avoidance control of controlling travel of the own vehicle (SV) such that the collision between the own vehicle (SV) and the object to be avoided (OB) is avoided, to execute processing of suppressing the collision avoidance control when a specific target (ST) is detected between the own vehicle (SV) and the object to be avoided (OB), and a positional relationship among the specific target (ST), the object to be avoided (OB), and the own vehicle (SV) satisfies a predetermined relationship.

With the above-mentioned configuration, the control unit (10) suppresses the collision avoidance control when the specific target (ST) exists between the own vehicle (SV) and the object to be avoided (OB), and the collision between the own vehicle (SV) and the object to be avoided (OB) can be avoided by the specific target (ST). As a result, unnecessary execution of the collision avoidance control is suppressed, and hence it is possible to effectively prevent the driver from being annoyed.

In another aspect of the present disclosure, the control unit (10) is configured to determine whether the predetermined condition is satisfied based on a positional relationship between the specific target (ST) and the object to be avoided (OB) and a length (L3) of an overhang of the own vehicle (SV) on a side facing the object to be avoided (OB).

According to this aspect, the unnecessary execution of the collision avoidance control can effectively be suppressed, and hence it is possible to effectively prevent the driver from being annoyed.

In another aspect of the present disclosure, the control unit (10) is configured to determine that the predetermined condition is satisfied when, in a case in which the own vehicle (SV) is moving backward, a total value of a distance (L2_{R}) from a rear end (R) of the own vehicle (SV) to the specific target (ST) and a length (L3_{R}) of a rear overhang of the own vehicle (SV) is shorter than a distance (L1_{R}) from the rear end (R) of the own vehicle (SV) to the object to be avoided (OB).

According to this aspect, when the own vehicle (SV) moves backward, the unnecessary execution of the collision avoidance control can reliably be suppressed, and hence it is possible to effectively prevent the driver from being annoyed.

In another aspect of the present disclosure, the control unit (10) is configured to determine that the predetermined condition is satisfied when, in a case in which the own vehicle (SV) is moving forward, a total value of a distance (L2_{F}) from a front end (F) of the own vehicle (SV) to the specific target (ST) and a length (L3_{F}) of a front overhang of the own vehicle (SV) is shorter than a distance (L1_{F}) from the front end (F) of the own vehicle (SV) to the object to be avoided (OB).

According to this aspect, when the own vehicle (SV) moves forward, the unnecessary execution of the collision avoidance control can reliably be suppressed, and hence it is possible to effectively prevent the driver from being annoyed.

In another aspect of the present disclosure, the specific target (ST) is a wheel stop (ST).

According to this aspect, when the collision between the own vehicle (SV) and the object to be avoided (OB) can reliably be avoided by the wheel stop (ST), the unnecessary execution of the collision avoidance control can reliably be suppressed.

In another aspect of the present disclosure, even when the predetermined condition is satisfied, the control unit (10) is configured to execute the collision avoidance control when an occupant executes an erroneous operation of erroneously depressing an accelerator pedal.

According to this aspect, when the driver erroneously depresses the accelerator pedal, it is possible to effectively prevent the own vehicle (SV) from colliding with the object to be avoided (OB).

In order to facilitate the understanding of the present disclosure, in the above description, the constituent features of the present disclosure corresponding to at least one embodiment of the present disclosure are suffixed in parentheses with reference symbols used in the at least one embodiment. However, the constituent features of the present disclosure are not intended to be limited to those in the at least one embodiment as defined by the reference symbols.

### BRIEF DESCRIPTION OF THE DRAWINGS

FIG. 1 is a schematic diagram for illustrating a hardware configuration of a driving assistance device according to at least one embodiment of the present disclosure.

FIG. 2 is a schematic diagram for illustrating a software configuration of the driving assistance device according to the at least one embodiment.

FIG. 3A is a schematic diagram for illustrating a positional relationship between an own vehicle and an object to be avoided (moving object) when the own vehicle is moving backward while moving substantially straight.

FIG. 3B is a schematic diagram for illustrating a positional relationship between an own vehicle and an object to be avoided (moving object) when the own vehicle is moving backward while turning.

FIG. 4A is a schematic diagram for illustrating a positional relationship between the own vehicle and an object to be avoided (stationary object) when the own vehicle is moving backward while moving substantially straight.

FIG. 4B is a schematic diagram for illustrating a positional relationship between the own vehicle and an object to be avoided (stationary object) when the own vehicle is moving backward while turning.

FIG. 5A is a schematic diagram for illustrating a positional relationship between the own vehicle and a wheel stop (specific target) when the own vehicle is moving backward while moving substantially straight.

FIG. 5B is a schematic diagram for illustrating a positional relationship between the own vehicle and a wheel stop (specific target) when the own vehicle is moving backward while turning.

FIG. 6A is a schematic diagram for illustrating a positional relationship between the own vehicle and the wheel stop (specific target) when the own vehicle is moving forward while moving substantially straight.

FIG. 6B is a schematic diagram for illustrating a positional relationship between the own vehicle and the wheel stop (specific target) when the own vehicle is moving forward while turning.

FIG. 7A is a schematic diagram for illustrating a state in which none of a camera and a sonar can detect the wheel stop (specific target) as the own vehicle moves backward.

FIG. 7B is a schematic diagram for illustrating a state in which none of a camera and a sonar can detect the wheel stop (specific target) as the own vehicle moves forward.

FIG. 8A is a schematic diagram for illustrating a positional relationship among the wheel stop, the object to be avoided, and the own vehicle as the own vehicle moves backward.

FIG. 8B is a schematic diagram for illustrating a positional relationship among the wheel stop, the object to be avoided, and the own vehicle moves forward.

FIG. 9 is a flowchart for illustrating a routine of collision avoidance control executed by an ECU when the vehicle moves backward.

FIG. 10 is a flowchart for illustrating a routine of collision avoidance control executed by the ECU when the vehicle moves forward.

### DESCRIPTION OF THE EMBODIMENTS

Description is now given of a driving assistance device, a driving assistance method, and a program according to at least one embodiment of the present disclosure with reference to the drawings.

[Hardware Configuration]

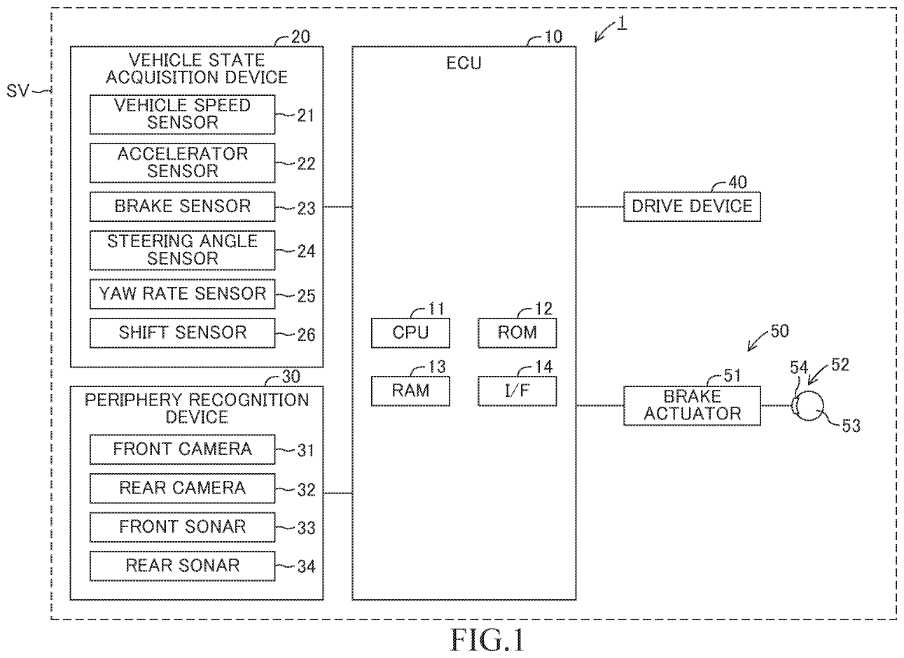

FIG. 1 is a schematic diagram for illustrating a hardware configuration of a driving assistance device 1 according to the at least one embodiment. The driving assistance device 1 is mounted to a vehicle SV. The vehicle SV is hereinafter sometimes referred to as “own vehicle” when it is required to distinguish the vehicle SV from other vehicles and the like.

The driving assistance device 1 includes an ECU 10. The ECU is an abbreviation for “electronic control unit.” The ECU 10 includes a central processing unit (CPU) 11, a read only memory (ROM) 12, a random access memory (RAM) 13, an interface device 14, and the like. The CPU 11 executes various programs stored in the ROM 12. The ROM 12 is a nonvolatile memory, and stores data required for the CPU 11 to execute the various programs. The RAM 13 is a volatile memory, and provides a work area in which the various programs are loaded when the various programs are to be executed by the CPU 11. The interface device 14 is a communication device for communicating to and from an external device.

The ECU 10 is a control device serving as a center of the execution of the driving assistance for a driver, and mainly executes collision avoidance control in the at least one embodiment. The collision avoidance control is control of operating an automatic braking system when an object to be avoided which is highly likely to collide with the own vehicle SV is detected in a traveling direction of the own vehicle SV, to thereby avoid the collision between the own vehicle SV and the object to be avoided. Thus, a vehicle state acquisition device 20, a periphery recognition device 30, a drive device 40, a brake device 50, and the like are connected to the ECU 10.

The vehicle state acquisition device 20 is sensors which acquire states of the vehicle SV. The vehicle state acquisition device 20 specifically includes a vehicle speed sensor 21, an accelerator sensor 22, a brake sensor 23, a steering angle sensor 24, a yaw rate sensor 25, a shift sensor 26, and the like.

The vehicle speed sensor 21 detects a travel speed of the vehicle SV (vehicle speed V). The vehicle speed sensor 21 may be a wheel speed sensor. The accelerator sensor 22 detects an operation amount of an accelerator pedal (not shown) by a driver. The brake sensor 23 detects an operation amount of a brake pedal (not shown) by the driver. The steering angle sensor 24 detects a steering angle θ of a steering wheel (or a steering shaft) (not shown). The yaw rate sensor 25 detects a yaw rate Yr of the vehicle SV. The shift sensor 26 detects shift ranges (parking range P, reverse range R, neutral range N, and drive range D) selected through use of a shift lever (not shown). The vehicle state acquisition device 20 transmits, to the ECU 10 at a predetermined cycle, the acquired various types of state information on the vehicle SV.

The periphery recognition device 30 is sensors which acquire information (target information) on targets existing in a peripheral region of the vehicle SV. Specifically, the periphery recognition device 30 includes a front camera 31, a rear camera 32, a front sonar 33, a rear sonar 34, and the like. The periphery recognition device 30 is not required to include all thereof, and may include only the front camera 31 and the rear camera 32. Moreover, the periphery recognition device 30 may further include a millimeter wave radar and Lidar. Further, the periphery recognition device 30 may be further configured to acquire target information not only in the front-and-rear direction of the vehicle SV, but in all orientations (front, rear, left, and right) thereof, that is, may further include a left side camera, a right side camera, a left side sonar, a right side sonar, and the like.

The front camera 31 is arranged, for example, in an upper portion of a front windshield inside a cabin or on a front bumper, and captures a front region of the vehicle SV. The rear camera 32 is arranged on, for example, a rear bumper, and captures a rear region of the vehicle SV. Each of the cameras 31 and 32 is, for example, a stereo camera or a monocular camera, and a digital camera including an image pickup element such as a CMOS sensor or a CCD sensor can be used. Each of the cameras 31 and 32 acquires a 3D object existing in the periphery of the vehicle SV based on a captured image, and transmits information (target information) on the acquired 3D object to the ECU 10 at a predetermined cycle. The target information is information including a type of the 3D object detected in the periphery of the vehicle SV, a size of the 3D object, and a relative position of the 3D object with respect to the vehicle SV. The type of the 3D object can be obtained through, for example, machine learning such as pattern matching.

The front sonar 33 is arranged, for example, on the front bumper, emits a sound wave toward the front region of the vehicle SV, and receives a reflected wave reflected by a 3D object. The rear sonar 34 is arranged, for example, on the rear bumper, emits a sound wave toward the rear region of the vehicle SV, and receives a reflected wave reflected by a 3D object. Each of the sonars 33 and 34 obtains target information including a reflection point being a point on a 3D object at which the transmitted sound wave is reflected and a distance to the reflection point based on a time from the transmission to the reception of the sound wave, and transmits the obtained target information to the ECU 10 at a predetermined cycle.

The ECU 10 synthesizes the target information transmitted from the front camera 31 and the target information transmitted from the front sonar 33 with each other, to thereby obtain front target information having a high accuracy. Further, the ECU 10 synthesizes the target information transmitted from the rear camera 32 and the target information transmitted from the rear sonar 34 with each other, to thereby obtain rear target information having a high accuracy.

The drive device 40 generates a driving force to be transmitted to driving wheels of the vehicle SV. As the drive device 40, for example, an electric motor and an engine are given. The vehicle SV may be any one of an engine vehicle, a hybrid vehicle (HEV), a plug-in hybrid electric vehicle (PHEV), a fuel cell electric vehicle (FCEV), and a battery electric vehicle (BEV).

The drive of the drive device 40 is controlled by the ECU 10. Specifically, the ECU 10 sets a driver requested torque based on an accelerator pedal operation amount detected by the accelerator sensor 22 and the vehicle speed V detected by the vehicle speed sensor 21, and controls the drive of the drive device 40 such that the drive device 40 outputs the driver requested torque. Moreover, when the ECU 10 executes collision avoidance control described later, the ECU 10 controls the operation of the drive device 40 such that an output torque of the drive device 40 is limited. Further, when the ECU 10 executes the collision avoidance control, even when the accelerator operation by the driver is executed, the ECU 10 controls the drive device 40 such that the accelerator operation is not received.

The brake device 50 is, for example, a disc brake device, and applies a braking force to the wheel of the vehicle SV. The brake device 50 includes a brake actuator 51. The brake actuator 51 is provided to a hydraulic circuit between a master cylinder (not shown) which pressurizes hydraulic fluid through a stepping force applied to the brake pedal and friction brake mechanisms 52 provided to left and right front wheels and left and right rear wheels. Each of the friction brake mechanisms 52 includes a brake disc 53 fixed to a wheel and a brake caliper 54 fixed to a vehicle body. The brake actuator 51 adjusts a hydraulic pressure of fluid supplied to a wheel cylinder built into the brake caliper 54, and operates the wheel cylinder through this hydraulic pressure to press brake pads against the brake disc 53, to thereby generate a friction braking force. The brake device 50 is not limited to the disc brake device, and may be another brake device such as a drum brake device which applies a braking force to the wheel of the vehicle SV.

The operation of the brake actuator 51 is controlled by the ECU 10. The ECU 10 sets a driver requested deceleration based on the operation amount of the brake pedal detected by the brake sensor 23, and controls the operation of the brake actuator 51 such that the vehicle SV decelerates at the driver requested deceleration. Moreover, when the brake pedal is operated by the driver during the execution of the collision avoidance control, the ECU 10 employs, as a final requested deceleration, one which is larger in absolute value out of the driver requested deceleration and an avoidance requested deceleration described later. The ECU 10 controls the operation of the brake actuator 51 such that the vehicle SV decelerates at the final requested deceleration. That is, the ECU 10 executes brake override.

[Software Configuration]

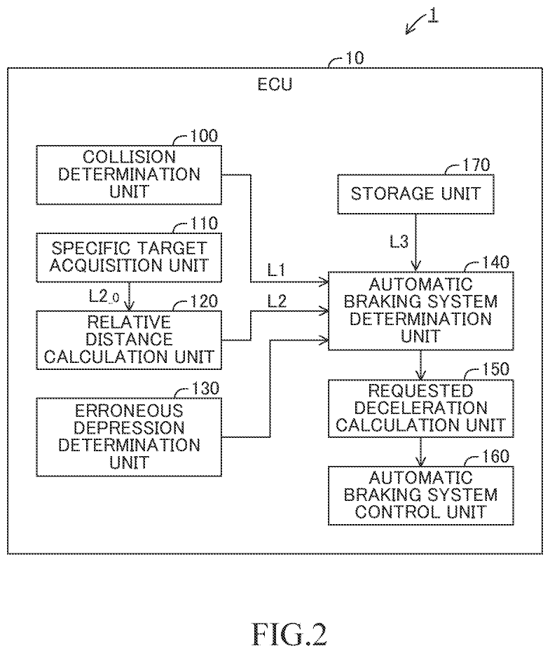

FIG. 2 is a schematic diagram for illustrating a software configuration of the driving assistance device 1 according to the at least one embodiment.

As illustrated in FIG. 2, the ECU 10 includes, as functional elements, a collision determination unit 100, a specific target acquisition unit 110, a relative distance calculation unit 120, an erroneous depression determination unit 130, an automatic braking system determination unit 140, a requested deceleration calculation unit 150, an automatic braking system control unit 160, and a storage unit 170. The collision determination unit 100, the specific target acquisition unit 110, the relative distance calculation unit 120, the erroneous depression determination unit 130, the automatic braking system determination unit 140, the requested deceleration calculation unit 150, and the automatic braking system control unit 160 are implemented by the CPU 11 of the ECU 10 reading out the programs stored in the ROM 12 onto the RAM 13, and executing the programs. The storage unit 170 is implemented as a part of the storage area provided by the ROM 12 of the ECU 10.

Each of the functional elements 100 to 170 is described as being included in the ECU 10 which is integrated hardware in the at least one embodiment, but any part thereof may be provided to another ECU independent of the ECU 10. Moreover, all or a part of the functional elements 100 to 170 of the ECU 10 may be provided in an information processing device installed at a facility (for example, a control center) which can communicate to and from the own vehicle SV.

The collision determination unit 100 determines whether or not the own vehicle SV collides with a 3D object (object to be avoided) existing in the traveling direction of the own vehicle SV. Specifically, the collision determination unit 100 calculates a trajectory of the own vehicle SV based on detection results obtained by the vehicle speed sensor 21, the steering angle sensor 24, and the yaw rate sensor 25. Moreover, the collision determination unit 100 extracts a 3D object which is likely to collide with the own vehicle SV based on the target information (the front target information when the own vehicle SV is moving forward and the rear target information when the own vehicle SV is moving backward) transmitted from the periphery recognition device 30. As the 3D object which is likely to collide with the own vehicle SV, it is only required to extract a 3D object higher in height from a road surface than, for example, a ground height of the wheel stop described later and a ground height of the own vehicle SV (height from the road surface to the lowest position of the vehicle body). Whether the own vehicle SV is moving forward or backward may be acquired based on the detection result obtained by the shift sensor 26.

When the collision determination unit 100 extracts a 3D object, the collision determination unit 100 determines whether or not this 3D object is a moving object or a stationary object. When the 3D object is a moving object, the collision determination unit 100 calculates a trajectory of this 3D object based on an amount of a change in a relative position of the 3D object with respect to the own vehicle SV and the like. The collision determination unit 100 determines whether or not the trajectory of the own vehicle SV and the trajectory of the 3D object intersects with each other when the own vehicle SV moves while maintaining a current travel state, and the 3D object moves while maintaining a current movement state. When the 3D object is stationary, the collision determination unit 100 executes this determination processing based on the trajectory of the own vehicle SV and a current position of the 3D object. When the trajectory of the own vehicle SV intersects with the trajectory of the 3D object (the position of the 3D object when the 3D object is a stationary object), the collision determination unit 100 selects this 3D object as an object OB to be avoided.

When the collision determination unit 100 selects the object OB to be avoided, the collision determination unit 100 obtains a relative distance L1 and a relative speed Vr between the own vehicle SV and the object OB to be avoided based on the target information (front target information or rear target information) transmitted from the periphery recognition device 30. Moreover, the collision determination unit 100 calculates a predicted time to collision (hereinafter referred to as “TTC”) until the own vehicle SV collides with the object OB to be avoided based on the obtained relative distance L1 and relative speed Vr. The TTC is an index value indicating a possibility that the own vehicle SV collides with the object OB to be avoided, and can be obtained by dividing the relative distance L1 by the relative speed Vr (TTC=L1/Vr).

The relative distance L1 is a distance from a front end of the own vehicle SV to the object OB to be avoided when the own vehicle SV is moving forward. The relative distance L1 is a distance from a rear end of the own vehicle SV to the object OB to be avoided when the own vehicle SV is moving backward. The collision determination unit 100 determines that the own vehicle SV is highly likely to collide with the object OB to be avoided when the TTC is equal to or shorter than a preset determination threshold value TTC1. Moreover, the collision determination unit 100 sequentially transmits the determination result and the relative distance L1 to the automatic braking system determination unit 140.

The specific target acquisition unit 110 determines whether or not a specific target exists between the own vehicle SV and the object OB to be avoided. The specific target herein is a target with which the wheel of the own vehicle SV comes in contact when the own vehicle SV moves toward the object OB to be avoided, and hence the own vehicle SV cannot further move toward the direction toward which the own vehicle SV approaches the object OB to be avoided. Specifically, the specific target is a road surface structure which is vertically arranged up to a height, from the road surface, equal to or lower than the ground height of the own vehicle SV, and has such shape and height that the wheel of the own vehicle SV cannot ride on when the wheel comes in contact with the road surface structure under a state in which the own vehicle SV is at a predetermined low speed (for example, 10 km/h) or the operation amount of the accelerator pedal is equal to or lower than a predetermined operation amount. As the specific target, for example, a wheel stop (car stop), a curb, and a step are given. In the at least one embodiment, description is given of the wheel stop as an example of the specific target.

The specific target acquisition unit 110 determines, when the collision determination unit 100 detects an object OB to be avoided in the rear region of the own vehicle SV, that is, the own vehicle SV is moving backward, whether or not a 3D object exists between the own vehicle SV and the object OB to be avoided based on the rear target information transmitted from the periphery recognition device 30. Further, the specific target acquisition unit 110 determines, when the collision determination unit 100 detects an object OB to be avoided in the front region of the own vehicle SV, that is, the own vehicle SV is moving forward, whether or not a 3D object exists between the own vehicle SV and the object OB to be avoided based on the front target information transmitted from the periphery recognition device 30.

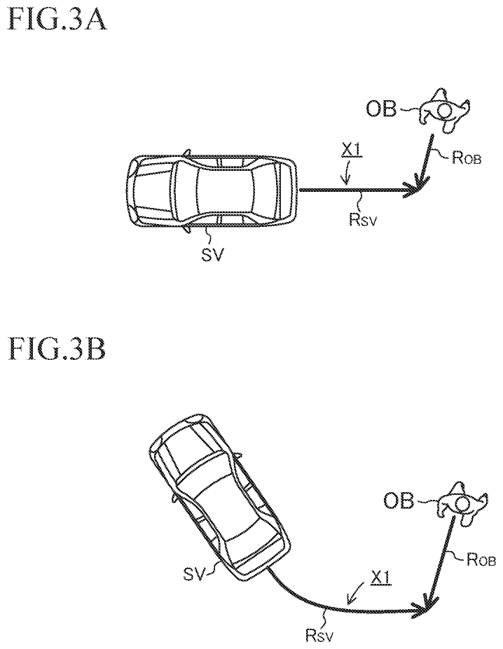

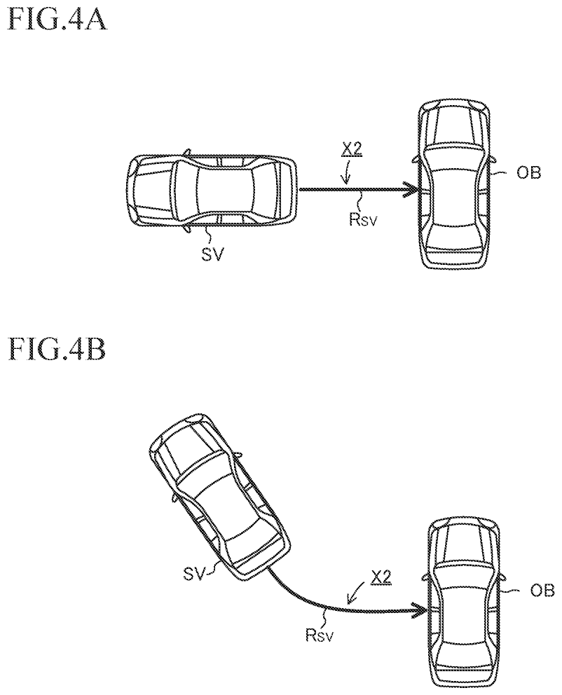

As illustration in FIG. 3A and FIG. 3B, when the object OB to be avoided is a moving object, the section between the own vehicle SV and the object OB to be avoided herein refers to a section X1 from the current position of the own vehicle SV to a position at which a trajectory R_{SV} of the own vehicle SV intersects with a trajectory Rog of the object OB to be avoided. That is, as illustrated in FIG. 3A, when the own vehicle SV is moving backward while moving substantially straight, the section X1 is a section of a straight line. As illustrated in FIG. 3B, when the own vehicle SV is moving backward while turning, the section X1 is a section including a curved line. Moreover, as illustration in FIG. 4A and FIG. 4B, when the object OB to be avoided is a stationary object, the section between the own vehicle SV and the object OB to be avoided herein means a section X2 from the current position of the own vehicle SV and a position at which the trajectory R_{SV} of the own vehicle SV intersects with the object OB to be avoided. That is, as illustrated in FIG. 4A, when the own vehicle SV is moving backward while moving substantially straight, the section X2 is a section of a straight line. As illustrated in FIG. 4B, when the own vehicle SV is moving backward while turning, the section X2 is a section including a curved line. In all of FIG. 3A, FIG. 3B, FIG. 4A, and FIG. 4B, the case in which the own vehicle SV is moving backward is exemplified. When the own vehicle is moving forward, the front-and-rear direction is only inverted, and hence a detailed illustration of such a case is omitted.

When the specific target acquisition unit 110 determines that a 3D object exists, the specific target acquisition unit 110 determines whether or not this 3D object is a wheel stop. The specific target acquisition unit 110 may determine whether or not the 3D object is a wheel stop by, for example, applying an edge detection filter or the like to each pixel of image data transmitted from the camera 31 and 32 to extract feature points, and collating the extracted feature points with feature point information on the wheel stop stored in advance in the storage unit 170. As another example, the height from the road surface and a width of the 3D object may be obtained based on the detection results obtained by the cameras 31 and 32 and the sonars 33 and 34, and the 3D object may be determined as a wheel stop when the obtained height and width are within predetermined threshold value ranges. It is only required to set the predetermined threshold value ranges considering dimensions of a general wheel stop as a reference.

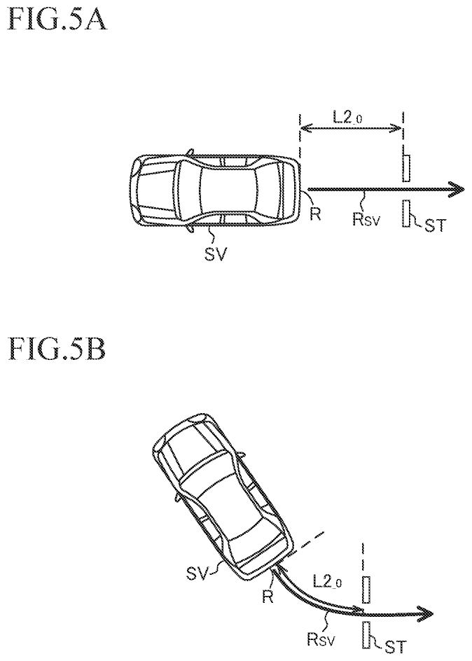

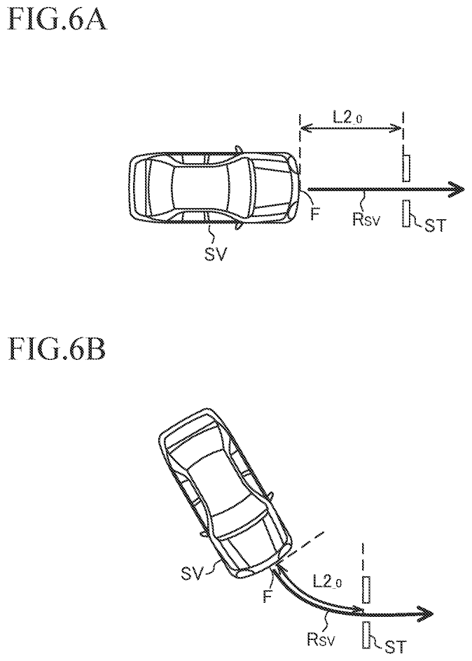

When the specific target acquisition unit 110 determines that the 3D object is a wheel stop, the specific target acquisition unit 110 acquires the relative distance of this wheel stop with respect to the own vehicle SV, and transmits the acquired relative distance to the relative distance calculation unit 120 as an initial relative distance L2_₀ of the wheel stop. Specifically, as illustrated in FIG. 5A and FIG. 5B, when a wheel stop ST exists in the rear of the own vehicle SV, the specific target acquisition unit 110 acquires, as the initial relative distance L2_₀, a relative distance of the wheel stop ST with respect to a rear end R of the own vehicle SV. Moreover, as illustrated in FIG. 6A and FIG. 6B, when the wheel stop ST exists in front of the own vehicle SV, the specific target acquisition unit 110 acquires, as the initial relative distance L2_₀, a relative distance of the wheel stop ST with respect to a front end F of the own vehicle SV.

The relative distance herein means a distance to the wheel stop ST along the trajectory R_{SV} of the own vehicle SV. That is, as illustrated in FIG. 5A and FIG. 6A, when the own vehicle SV approaches the wheel stop ST while substantially moving straight, the initial relative distance L2_₀ is a distance along a straight line connecting between the own vehicle SV and the wheel stop ST. Meanwhile, as illustrated in FIG. 5B and FIG. 6B, when the own vehicle SV approaches the wheel stop ST while turning, the initial relative distance L2_₀ is a distance including a curved line connecting between the own vehicle SV and the wheel stop ST. It is only required that a timing at which the initial relative distance L2_₀ is acquired be a timing before the wheel stop ST deviates from the detection ranges of the cameras 31 and 32 and the sonars 33 and 34 as the own vehicle SV approaches the wheel stop ST.

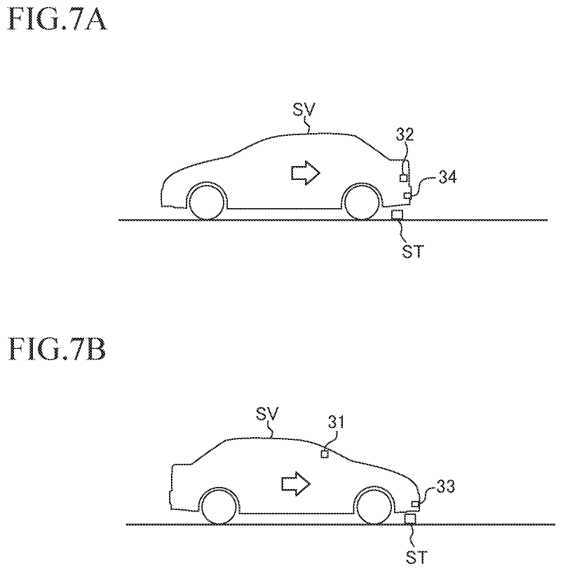

The relative distance calculation unit 120 calculates the relative distance L2 of the wheel stop ST with respect to the own vehicle SV at a predetermined cycle when the own vehicle SV is approaching the wheel stop ST. As illustrated in FIG. 7A, when the wheel stop ST comes under a lower portion of the vehicle body of the own vehicle SV as the own vehicle SV moves backward, the wheel stop ST can no longer be recognized by the rear camera 32 and the rear sonar 34. Similarly, as illustrated in FIG. 7B, when the wheel stop ST comes under the lower portion of the vehicle body of the own vehicle SV as the own vehicle SV moves forward, the wheel stop ST can no longer be recognized by the front camera 31 and the front sonar 33.

When the relative distance calculation unit 120 receives the initial relative distance L2_₀ of the wheel stop ST from the specific target acquisition unit 110, the relative distance calculation unit 120 subsequently sequentially subtracts a position change amount ΔL of the own vehicle SV from the initial relative distance L2_₀, to thereby calculate the relative distance L2 (=L2_₀−ΔL) in real time. It is only required to calculate the position change amount ΔL of the own vehicle SV through, for example, odometry based on the detection results obtained by the vehicle speed sensor 21, the steering angle sensor 24, and the yaw rate sensor 25.

The erroneous depression determination unit 130 determines whether or not the driver has executed an erroneous depression (erroneous operation) of erroneously depressing the accelerator pedal when the collision determination unit 100 determines that the own vehicle SV and the object OB to be avoided are highly likely to collide with each other. It is considered that the driver does not usually execute a sudden or large accelerator operation when the own vehicle SV is approaching the object OB to be avoided. When a sudden or large accelerator operation amount is detected in this state, it can be predicted that this accelerator operation is an erroneous depression of the driver. The erroneous depression determination unit 130 determines that the accelerator operation by the driver is an erroneous depression when it is determined that the own vehicle SV and the object OB to be avoided are highly likely to collide with each other, and a change amount per unit time of an accelerator pedal operation amount AP detected by the accelerator sensor 22 exceeds a predetermined threshold change amount.

The automatic braking system determination unit 140 determines whether or not the automatic braking system is to be operated, that is, the collision avoidance control is to be suppressed when the collision determination unit 100 determines that the possibility of the collision is high. Even when the collision determination unit 100 determines that the possibility of collision is high, but a wheel stop ST exists between the own vehicle SV and the object OB to be avoided, the collision may be avoided even when the automatic braking system is not operated. When the automatic braking system is operated also in this case, the driver may be annoyed.

The automatic braking system determination unit 140 determines that the operation of the automatic braking system is not required even when the collision determination unit 100 determines that the possibility of the collision is high when the own vehicle SV is moving backward or forward, but a positional relationship among the own vehicle SV, the wheel stop ST, and the object OB to be avoided satisfies the following conditions.

[Condition for Backward Movement]

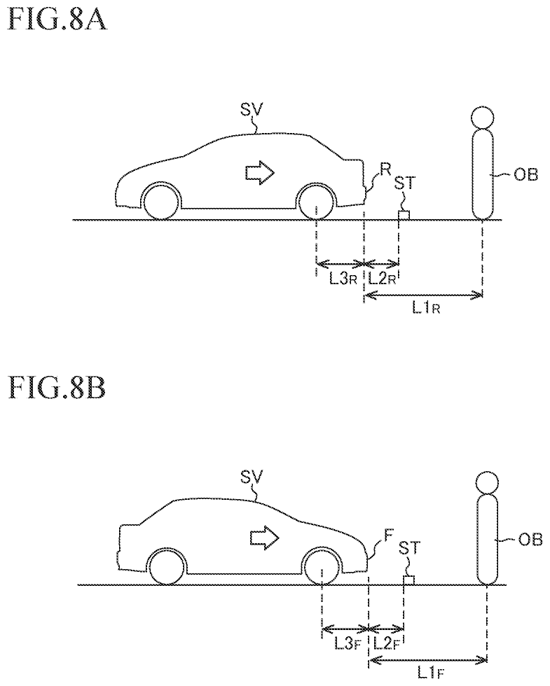

As illustrated in FIG. 8A, a condition for backward movement is a case in which a relative distance L1_{R} of the object OB to be avoided with respect to the rear end R of the own vehicle SV is longer than a total value of a relative distance L2_{R} of the wheel stop ST with respect to the rear end R of the own vehicle SV and a length L3_{R} of a rear overhang (L1_{R}>L2_{R}+L3_{R}).

[Condition for Forward Movement]

As illustrated in FIG. 8B, a condition for forward movement is a case in which a relative distance L1_{F} of the object OB to be avoided with respect to the front end F of the own vehicle SV is longer than a total value of a relative distance L2_{F} of the wheel stop ST with respect to the front end F of the own vehicle SV and a length L3_{F} of a front overhang (L1_{F}>L2_{F}+L3_{F}).

As illustrated in FIG. 8A, the length L3_{R} of the rear overhang is a length from a center of an axle of the rear wheel WR to the rear end R (for example, a portion of the rear bumper most protruding backward). Moreover, as illustrated in FIG. 8B, the length L3_{F} of the front overhang is a length from a center of an axle of the front wheel WF to the front end F (for example, a portion of the front bumper most protruding forward). It is only required that the values of the length L3_{R} of the rear overhang and the length L3_{F} of the front overhang be stored in advance in the storage unit 170 of the ECU 10.

The automatic braking system determination unit 140 determines that the operation of the automatic braking system is required when the collision determination unit 100 determines that the possibility of the collision is high, and a wheel stop ST does not exist between the own vehicle SV and the object OB to be avoided. Moreover, the automatic braking system determination unit 140 determines that the operation of the automatic braking system is required even when the collision determination unit 100 determines that the possibility of the collision is high, and a wheel stop ST exists between the own vehicle SV and the object OB to be avoided, but the above-mentioned condition is not satisfied. That is, the collision avoidance control is executed. As a result, even when the object OB to be avoided exists at a position closer to the wheel stop ST than the length L3_{R} of the rear overhang or the length L3_{F} of the front overhang or approaches this position, the collision of the own vehicle SV with the object OB to be avoided can effectively be prevented.

Even when a wheel stop ST exists between the own vehicle SV and the object OB to be avoided, and the above-mentioned condition is satisfied, but the driver erroneously depresses the accelerator pedal, the wheel of the own vehicle SV may get over the wheel stop ST. Thus, the automatic braking system determination unit 140 determines that the operation of the automatic braking system is required even when the above-mentioned condition is satisfied, but the erroneous depression determination unit 130 determines that the driver has erroneously depressed the accelerator pedal. As a result, it is possible to effectively prevent the own vehicle SV from getting over the wheel stop ST to collide with the object OB to be avoided.

The requested deceleration calculation unit 150 calculates a requested deceleration (hereinafter referred to as “avoidance requested deceleration Gp”) of the own vehicle SV required to avoid the collision between the own vehicle SV and the object OB to be avoided when the collision determination unit 100 determines that the possibility of the collision is high, and the automatic braking system determination unit 140 determines that the operation of the automatic braking system is required. It is only required that the avoidance requested deceleration Gp be set to a higher deceleration as the relative distance L1 to the object OB to be avoided becomes shorter and the relative speed Vr becomes higher. Moreover, it is only required that the avoidance requested deceleration Gp be set to a lower deceleration as the relative distance L1 to the object OB to be avoided becomes longer and the relative speed Vr becomes lower. The requested deceleration calculation unit 150 transmits the calculated avoidance requested deceleration Gp to the automatic braking system control unit 160.

The automatic braking system control unit 160 controls the operation of the brake actuator 51 such that the own vehicle SV decelerates at the avoidance requested deceleration Gp transmitted from the requested deceleration calculation unit 150. As a result, the friction braking forces are generated on the right and left front and rear wheels without requiring the brake pedal operation of the driver, and hence the own vehicle SV can forcibly be decelerated. As described above, the control of decelerating the own vehicle SV based on the avoidance requested deceleration Gp is the collision avoidance control. The automatic braking system control unit 160 monitors whether or not the own vehicle SV is brought into the state in which the own vehicle SV can avoid the collision as a result of the execution of the automatic braking system. Specifically, when the vehicle SV stops before the obstacle, or the TTC becomes equal to or longer a predetermined finish threshold value TTC2 as a result of the automatic braking system, the automatic braking system control unit 160 determines that the own vehicle SV is brought into a state in which the own vehicle SV can avoid the collision, and hence stops the automatic braking system, that is, finishes the collision avoidance control.

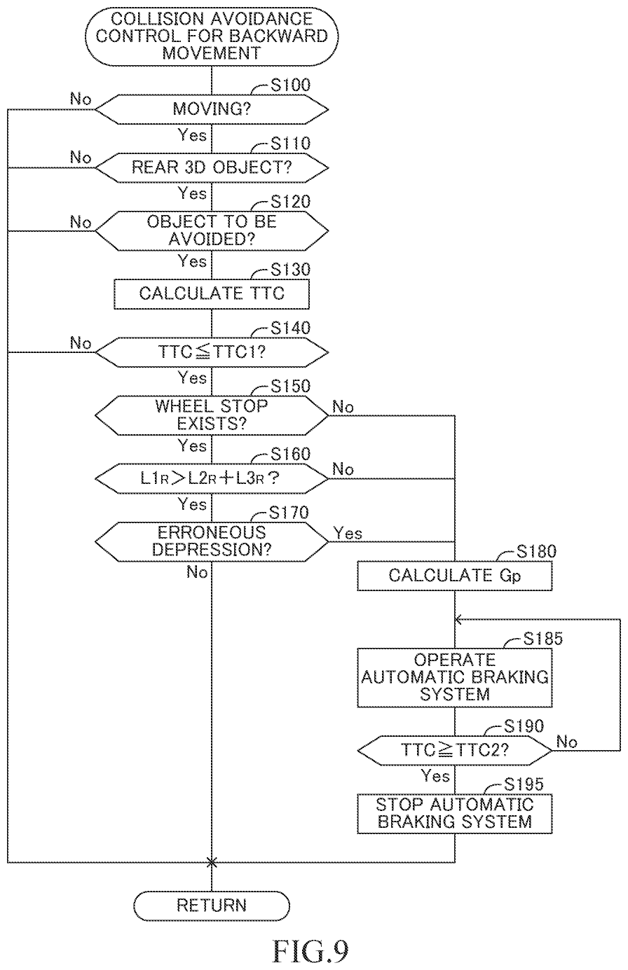

Referring to a flowchart of FIG. 9, description is now given of a routine for the collision avoidance control for the backward movement. This routine is executed when the own vehicle SV moves backward. For the determination of whether or not the own vehicle SV is moving backward, it is only required to determine that the own vehicle SV is moving backward when, for example, the shift range detected by the shift sensor 26 is the reverse range R.

In Step S100, the ECU 10 determines whether or not the own vehicle SV is moving based on the detection result obtained by the vehicle speed sensor 21. When the own vehicle SV is moving (Yes), the ECU 10 advances the process to Step S110. Meanwhile, when the own vehicle SV is not moving (No), that is, the own vehicle SV is stopped, the ECU 10 returns from (temporarily finishes) this routine.

In Step S110, the ECU 10 determines whether or not a 3D object exists in the rear of the own vehicle SV based on the rear target information acquired by the periphery recognition device 30. When a rear 3D object exists (Yes), the ECU 10 advances the process to Step S120. Meanwhile, when a rear 3D object does not exist (No), the ECU 10 returns from (temporarily finishes) this routine.

In Step S120, the ECU 10 determines whether or not the rear 3D object is an object OB to be avoided which is likely to collide with the own vehicle SV based on the trajectory of the own vehicle SV and the trajectory of the rear 3D object (position of the rear 3D object when the rear 3D object is a stationary object). When the rear 3D object is an object OB to be avoided (Yes), the ECU 10 advances the process to Step S130. Meanwhile, when the rear 3D object is not an object OB to be avoided (No), the ECU 10 returns from (temporarily finishes) this routine.

In Step S130, the ECU 10 divides the relative distance L1_{R} between the own vehicle SV and the object OB to be avoided by the relative speed Vr, to thereby calculate the TTC. After that, in Step S140, the ECU 10 determines whether or not the TTC is equal to or shorter than the determination threshold value TTC1. When TTC is longer than the determination threshold value TTC1 (No), the ECU 10 returns from (temporarily finishes) this routine. Meanwhile, when the TTC is equal to or shorter than the determination threshold value TTC1 (Yes), the ECU 10 advances the process to Step S150.

In Step S150, the ECU 10 determines whether or not a wheel stop ST exists between the own vehicle SV and the object OB to be avoided. When a wheel stop ST exists (Yes), the ECU 10 advances the process to Step S160. Meanwhile, when a wheel stop ST does not exist (No), the ECU 10 advances the process to Step S180.

In Step S180, the ECU 10 calculates the avoidance requested deceleration Gp required to avoid the collision between the own vehicle SV and the object OB to be avoided. After that, in Step S185, the ECU 10 executes the automatic braking for decelerating the own vehicle SV at the avoidance requested deceleration Gp. In Step S190, the ECU 10 determines whether or not the own vehicle SV has stopped, or the TTC becomes equal to or longer than the finish threshold value TTC2 as a result of the operation of the automatic braking system. When the determination result is negative (No), the ECU 10 returns the process to Step S185. That is, the ECU 10 continues the operation of the automatic braking system. Meanwhile, the determination result is affirmative (Yes), the ECU 10 advances the process to Step S195, stops the automatic braking system, and returns from (temporarily finishes) this routine.

When the process is advanced from Step S150 to Step S160, the ECU 10 determines whether or not the positional relationship among the own vehicle SV, the wheel stop ST, and the object OB to be avoided satisfies the above-mentioned condition for backward movement. Specifically, the ECU 10 determines whether or not the relative distance L1_{R} of the object OB to be avoided with respect to the rear end R of the own vehicle SV is longer than the total value of the relative distance L2_{R} of the wheel stop ST with respect to the rear end R of the own vehicle SV and the length L3_{R} of the rear overhang. When the condition for backward movement is satisfied (Yes), the ECU 10 advances the process to Step S170. Meanwhile, when the condition for backward movement is not satisfied (No), the ECU 10 advances the process to Step S180. That is, the ECU 10 operates the automatic braking system. As a result, even when the object OB to be avoided exists at a position closer to the wheel stop ST than the length L3_{R} of the rear overhang of the own vehicle SV or approaches this position, it is possible to effectively prevent the own vehicle SV from colliding with the object OB to be avoided in the rear.

When the process is advanced from Step S160 to Step S170, the ECU 10 determines whether or not the driver has executed the erroneous depression, which is the erroneous operation of the accelerator pedal by the driver. When the driver has erroneously depressed the accelerator pedal (Yes), the ECU 10 advances the process to Step S180. That is, the ECU 10 operates the automatic braking system. As a result, it is possible to effectively prevent the own vehicle SV from getting over the wheel stop ST to collide with the object OB to be avoided in the rear. Meanwhile, when the driver has not erroneously depressed the accelerator pedal (No), the ECU 10 returns from (temporarily finishes) this routine without operating the automatic braking system. That is, when the wheel stop ST exists between the own vehicle SV and the object OB to be avoided, the positional relationship satisfies the above-mentioned condition for backward movement, and the accelerator pedal has not been erroneously depressed, the operation of the automatic braking system is suppressed. As a result, unnecessary operation of the automatic braking system can effectively be prevented.

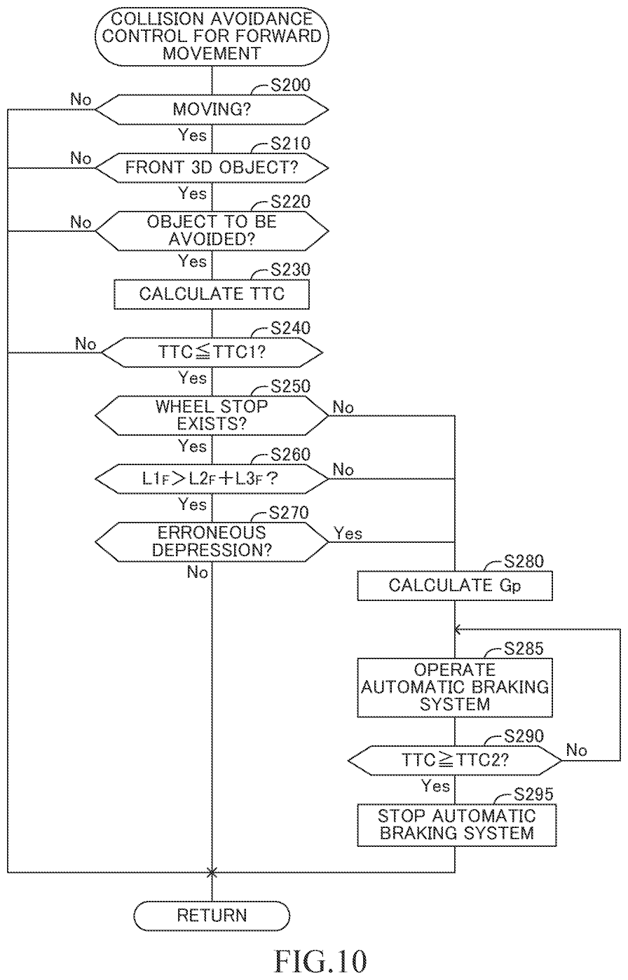

Referring to a flowchart of FIG. 10, description is now given of a routine for the collision avoidance control for the forward movement. This routine is executed when the own vehicle SV moves forward. For the determination of whether or not the own vehicle SV is moving forward, it is only required to determine that the own vehicle SV is moving forward when, for example, the shift range detected by the shift sensor 26 is the drive range D.

In Step S200, the ECU 10 determines whether or not the own vehicle SV is moving based on the detection result obtained by the vehicle speed sensor 21. When the own vehicle SV is moving (Yes), the ECU 10 advances the process to Step S210. Meanwhile, when the own vehicle SV is not moving (No), that is, the own vehicle SV is stopped, the ECU 10 returns from (temporarily finishes) this routine.

In Step S210, the ECU 10 determines whether or not a 3D object exists in front of the own vehicle SV based on the front target information acquired by the periphery recognition device 30. When a front 3D object exists (Yes), the ECU 10 advances the process to Step S220. Meanwhile, when a front 3D object does not exist (No), the ECU 10 returns from (temporarily finishes) this routine.

In Step S220, the ECU 10 determines whether or not the front 3D object is an object OB to be avoided which is likely to collide with the own vehicle SV based on the trajectory of the own vehicle SV and the trajectory of the front 3D object (position of the front 3D object when the front 3D object is a stationary object). When the front 3D object is an object OB to be avoided (Yes), the ECU 10 advances the process to Step S230. Meanwhile, when the front 3D object is not an object OB to be avoided (No), the ECU 10 returns from (temporarily finishes) this routine.

In Step S230, the ECU 10 divides the relative distance L1_{F} between the own vehicle SV and the object OB to be avoided by the relative speed Vr with respect to the object OB to be avoided, to thereby calculate the TTC. After that, in Step S240, the ECU 10 determines whether or not the TTC is equal to or shorter than the determination threshold value TTC1. When TTC is longer than the determination threshold value TTC1 (No), the ECU 10 returns from (temporarily finishes) this routine. Meanwhile, when the TTC is equal to or shorter than the determination threshold value TTC1 (Yes), the ECU 10 advances the process to Step S250.

In Step S250, the ECU 10 determines whether or not a wheel stop ST exists between the own vehicle SV and the object OB to be avoided. When a wheel stop ST exists (Yes), the ECU 10 advances the process to Step S260. Meanwhile, when a wheel stop ST does not exist (No), the ECU 10 advances the process to Step S280.

In Step S280, the ECU 10 calculates the avoidance requested deceleration Gp required to avoid the collision between the own vehicle SV and the object OB to be avoided. After that, in Step S285, the ECU 10 executes the automatic braking for decelerating the own vehicle SV at the avoidance requested deceleration Gp. In Step S290, the ECU 10 determines whether or not the own vehicle SV has stopped, or the TTC becomes equal to or longer than the finish threshold value TTC2 as a result of the operation of the automatic braking system. When the determination result is negative (No), the ECU 10 returns the process to Step S285. That is, the ECU 10 continues the operation of the automatic braking system. Meanwhile, the determination result is affirmative (Yes), the ECU 10 advances the process to Step S295, stops the automatic braking system, and returns from (temporarily finishes) this routine.

When the process is advanced from Step S250 to Step S260, the ECU 10 determines whether or not the positional relationship among the own vehicle SV, the wheel stop ST, and the object OB to be avoided satisfies the above-mentioned condition for forward movement. Specifically, the ECU 10 determines whether or not the relative distance L1_{F} of the object OB to be avoided with respect to the front end F of the own vehicle SV is longer than the total value of the relative distance L2_{F} of the wheel stop ST with respect to the front end F of the own vehicle SV and the length L3f of the front overhang. When the condition for forward movement is satisfied (Yes), the ECU 10 advances the process to Step S270. Meanwhile, when the condition for forward movement is not satisfied (No), the ECU 10 advances the process to Step S280. That is, the ECU 10 operates the automatic braking system. As a result, even when the object OB to be avoided exists at a position closer to the wheel stop ST than the length L3_{F} of the front overhang of the own vehicle SV or approaches this position, it is possible to effectively prevent the own vehicle SV from colliding with the object OB to be avoided in the front.

When the process is advanced from Step S260 to Step S270, the ECU 10 determines whether or not the driver has executed the erroneous depression, which is the erroneous operation of the accelerator pedal by the driver. When the driver has erroneously depressed the accelerator pedal (Yes), the ECU 10 advances the process to Step S280. That is, the ECU 10 operates the automatic braking system. As a result, it is possible to effectively prevent the own vehicle SV from getting over the wheel stop ST, and then colliding with the object OB to be avoided in the front. Meanwhile, when the driver has not erroneously depressed the accelerator pedal (No), the ECU 10 returns from (temporarily finishes) this routine without operating the automatic braking system. That is, when the wheel stop ST exists between the own vehicle SV and the object OB to be avoided, the positional relationship satisfies the above-mentioned condition for forward movement, and the accelerator pedal has not been erroneously depressed, the operation of the automatic braking system is suppressed. As a result, unnecessary operation of the automatic braking system can effectively be prevented.

According to the at least one embodiment described in detail above, when the ECU 10 detects, in the traveling direction of the own vehicle SV, an object OB to be avoided which is highly likely to collide with the own vehicle SV, the ECU 10 calculates the TTC being the predicted time to collision until the own vehicle SV collides with the object OB to be avoided. The ECU 10 determines that the operation of the automatic braking system is not required even when the TTC is equal to or shorter than the determination threshold value TTC1, but a wheel stop ST (specific target) exists between the own vehicle SV and the object OB to be avoided, and the positional relationship among the wheel stop ST, the object OB to be avoided, and the own vehicle SV satisfies the predetermined condition.

Specifically, the ECU 10 determines that the operation of the automatic braking system is not required when the own vehicle SV is moving backward, and the relative distance L1_{R} of the object OB to be avoided with respect to the rear end R of the own vehicle SV is longer than the total value of the relative distance L2_{R} of the wheel stop ST with respect to the rear end R of the own vehicle SV and the length L3_{R} of the rear overhang (L1_{R}>L2_{F}+L3_{R}). Further, the ECU 10 determines that the operation of the automatic braking system is not required when the own vehicle SV is moving forward, and the relative distance L1_{F} of the object OB to be avoided with respect to the front end F of the own vehicle SV is longer than the total value of the relative distance L2_{F} of the wheel stop ST with respect to the front end F of the own vehicle SV and the length L3_{F} of the front overhang (L1_{F}>L2_{F}+L3_{F}).

That is, the operation of the automatic braking system is suppressed when the wheel stop ST exists between the own vehicle SV and the object OB to be avoided, and the collision between the own vehicle SV and the object OB to be avoided is avoided by the wheel stop ST. As a result, it is possible to prevent the operation of the unnecessary automatic braking system, and hence it is possible to effectively prevent the driver from being annoyed.

[Others]

In the above, the driving assistance device, the driving assistance method, and the program according to the at least one embodiment have been described, but the present disclosure is not limited to the above-mentioned at least one embodiment, and various modifications are possible within the range not departing from the object of the present disclosure.

For example, the object OB to be avoided is a stationary object, the relative distance between the wheel stop ST and the object OB to be avoided is invariable. Thus, when the ECU 10 once acquires the relative distance between the wheel stop ST and the object OB to be avoided, it is not required to subsequently acquire or calculate the relative distance. That is, even when the camera 31 and 32 and the sonars 33 and 34 can no longer recognize the wheel stop ST as the own vehicle SV approaches the wheel stop ST, the ECU 10 can continuously hold the relative distance.

In this case, the ECU 10 may determine whether or not the automatic braking system is to be operated by comparing the relative distance between the wheel stop ST and the object OB to be avoided with the length L3_{R} of the rear overhang or the length L3_{F} of the front overhang of the own vehicle SV. Specifically, it is only required to determine that the operation of the automatic braking system is not required when the own vehicle SV is moving backward and the relative distance between the wheel stop ST and the object OB to be avoided is longer than the length L3_{R} of the rear overhang. Moreover, it is only required to determine that the operation of the automatic braking system is not required when the own vehicle SV is moving forward and the relative distance between the wheel stop ST and the object OB to be avoided is longer than the length L3_{F} of the front overhang.

Moreover, in the description of the at least one embodiment, the automatic braking system is operated as the collision avoidance control, but other travel control may be executed as long as this travel control can avoid the collision with the object OB to be avoided. cm What is claimed is:

1. A driving assistance device, comprising:
a target acquisition unit configured to acquire a target existing in a periphery of an own vehicle; and
a control unit configured to execute, when the target acquired by the target acquisition unit is determined as an object to be avoided which is highly likely to collide with the own vehicle, collision avoidance control of controlling travel of the own vehicle such that the collision between the own vehicle and the object to be avoided is avoided,
wherein the control unit is configured to suppress the collision avoidance control when a specific target is detected between the own vehicle and the object to be avoided, and a positional relationship among the specific target, the object to be avoided, and the own vehicle satisfies a predetermined condition.

2. The driving assistance device according to claim 1, wherein the control unit is configured to determine whether the predetermined condition is satisfied based on a positional relationship between the specific target and the object to be avoided and a length of an overhang of the own vehicle on a side facing the object to be avoided.

3. The driving assistance device according to claim 1, wherein the control unit is configured to determine that the predetermined condition is satisfied when, in a case in which the own vehicle is moving backward, a total value of a distance from a rear end of the own vehicle to the specific target and a length of a rear overhang of the own vehicle is shorter than a distance from the rear end of the own vehicle to the object to be avoided.

4. The driving assistance device according to claim 1, wherein the control unit is configured to determine that the predetermined condition is satisfied when, in a case in which the own vehicle is moving forward, a total value of a distance from a front end of the own vehicle to the specific target and a length of a front overhang of the own vehicle is shorter than a distance from the front end of the own vehicle to the object to be avoided.

5. The driving assistance device according to claim 1, wherein the specific target is a wheel stop.

6. The driving assistance device according to claim 1, wherein, even when the predetermined condition is satisfied, the control unit is configured to execute the collision avoidance control when an occupant of the own vehicle executes an erroneous operation of erroneously depressing an accelerator pedal.

7. The driving assistance device according to claim 2, wherein the control unit is configured to determine that the predetermined condition is satisfied when, in a case in which the own vehicle is moving backward, a total value of a distance from a rear end of the own vehicle to the specific target and a length of a rear overhang of the own vehicle is shorter than a distance from the rear end of the own vehicle to the object to be avoided.

8. The driving assistance device according to claim 2, wherein the control unit is configured to determine that the predetermined condition is satisfied when, in a case in which the own vehicle is moving forward, a total value of a distance from a front end of the own vehicle to the specific target and a length of a front overhang of the own vehicle is shorter than a distance from the front end of the own vehicle to the object to be avoided.

9. The driving assistance device according to claim 2, wherein the specific target is a wheel stop.

10. The driving assistance device according to claim 2, wherein, even when the predetermined condition is satisfied, the control unit is configured to execute the collision avoidance control when an occupant of the own vehicle executes an erroneous operation of erroneously depressing an accelerator pedal.

11. A driving assistance method, comprising:
acquiring a target existing in a periphery of an own vehicle;
executing, when the acquired target is determined as an object to be avoided which is highly likely to collide with the own vehicle, collision avoidance control of controlling travel of the own vehicle such that the collision between the own vehicle and the object to be avoided is avoided; and
suppressing the collision avoidance control when a specific target is detected between the own vehicle and the object to be avoided, and a positional relationship among the specific target, the object to be avoided, and the own vehicle satisfies a predetermined condition.

12. A program for causing a computer of a driving assistance device for acquiring a target existing in a periphery of an own vehicle, and executing, when the acquired target is determined as an object to be avoided which is highly likely to collide with the own vehicle, collision avoidance control of controlling travel of the own vehicle such that the collision between the own vehicle and the object to be avoided is avoided, to execute processing of suppressing the collision avoidance control when a specific target is detected between the own vehicle and the object to be avoided, and a positional relationship among the specific target, the object to be avoided, and the own vehicle satisfies a predetermined condition.
